(19) United States
(12) Patent Application Publication
(10) Pub. No.: US 2009/0140572 A1
(43) Pub. Date: Jun. 4, 2009

(54) PRESSURE SENSOR

(75) Inventor: Chae Soo Kim, Gunpo-si (KR)

Correspondence Address: SEED INTELLECTUAL PROPERTY LAW GROUP PLLC, 701 FIFTH AVE, SUITE 5400, SEATTLE, WA, 98104, US

(73) Assignee: MANDO CORPORATION, Pyeongtaek-si (KR)

(21) Appl. No.: 12/328,666

(22) Filed: Dec. 4, 2008

(30) Foreign Application Priority Data
Dec. 4, 2007 (KR) 10-2007-0125046
Dec. 5, 2007 (KR) 10-2007-0125529

(51) Int. Cl. B60T 13/68; G01L 9/00

(52) U.S. Cl. 303/17; 73/753

(57) ABSTRACT

The present invention relates to a pressure sensor employed in a stability control apparatus for a vehicle. According to an aspect, there is provided a pressure sensor installed to a hydraulic unit and being in contact with a circuit board of an electronic control unit to sense brake oil pressure. The pressure sensor comprises a connecting terminal formed on the circuit board of the electronic control board and comprising a press-fit terminal; a press-fit being in slidable and movable contact with the press-fit terminal; and a spring connecting the press-fit and the press-fit terminal.

### BACKGROUND OF THE INVENTION

1. Technical Field

The present invention relates to a pressure sensor employed in a stability control apparatus for a vehicle, and more particularly, to a pressure sensor, which makes it possible to be in stable contact with an electronic control unit under a condition where an excessive vibration is generated.

2. Description of the Related Art

In general, a vehicle is provided with a brake system for reducing speed or braking. The brake system comprises a pedal for transmitting driver's operating force, a booster and a master cylinder connected to the pedal to generate brake oil pressure, and a wheel brakes for braking wheels of the vehicle according to the brake oil pressure inputted from the booster and the master cylinder.

In the brake system, when the driver steps on the brake pedal to generate the braking force, if the braking force is larger than a road friction force or the friction force generated on the wheel brake by the braking force is larger than the braking force generated on a tire or road surface, a slip phenomenon where the tire skids on the road surface is generated.

In the meantime, in a state where the brake operates as described above, a steering system becomes locked, and thus, the driver cannot steer the vehicle in his or her desired direction.

Accordingly, an anti-lock brake system (ABS) which electronically controls brake pedal force has been developed such that a driver can steer a vehicle in his or her desired direction when the slip phenomenon is generated.

The anti-lock brake system comprises a hydraulic unit to which a plurality of solenoid valves, low-pressure accumulators and high-pressure accumulators for adjusting brake oil pressure to be transmitted to the wheel brake and an electronic control unit (ECU) for controlling components that electronically operate.

The hydraulic unit is also provided with a pressure sensor for sensing brake operating pressure generated in the master cylinder in proportion to the brake pedal force generated by a driver and transmitting an electrical signal on the sensed brake operating pressure to the electronic control unit. The electronic control unit controls the operation of the brake in response to the electrical signal transmitted from the pressure sensor.

FIG. 1 is an exploded perspective view of a pressure sensor 10 according to a prior art. Referring to FIG. 1, the pressure sensor 10 is mounted in a hole formed at a leading end of a master cylinder and electrically connected to a circuit board of an electronic control unit through additional connector and cable.

The pressure sensor 10 comprises pin members 24, which is in contact with the circuit board of the electronic control unit, and a lower guide 26, which guides movement of the pin members 24 and to which a contact board 22 is coupled. In addition, a spring 25 is coupled to each of the pin members 24 to elastically support the pin member 24.

Furthermore, an upper guide 18 is coupled to an upper portion of the contact board 22, and an electric component module 16 having a pressure sensing unit and a control unit provided therein is coupled to an upper portion of the upper guide 18. In the meantime, springs 20 electrically connecting the contact board 22 and the electric component module 16 are installed to the upper guide 18.

Also, a sensor module 14 in which various kinds of sensors are mounted is installed to an upper portion of the electric component module 16.

The various kinds of components of the pressure sensor 10 are integrally configured by a housing 12. In the meantime, O-rings 12a and 12b are installed at upper and lower portions of the housing 12.

In a case where the braking force is generated by the driver's brake pedal force, an electrical signal is generated in the pressure sensor 10 by a small vibration. Then, the pressure sensor 10 is electrically connected to the circuit board by the pin members 24 which are elastically urged by the springs 25, whereby the electrical signal generated in the pressure sensor 10 is transmitted to the electronic control unit.

However, the pressure sensor 10 according to the prior art has a problem in that if large vibration is generated, the springs 20 and 24 may be compressed and thus the pin member 24 may be separated from the circuit board of the electronic control unit. Also, in the conventional pressure sensor 10, the pin members 24 are not accurately connected to terminals of the circuit board, whereby signal transmission or electrical connection becomes unstable due to a contact error caused by the inaccurate connection. Furthermore, in the conventional pressure sensor 10, since the pin members 24, which are in contact with the circuit board, are made of a rigid material, when shock is applied, the pin members 24 are inertially moved by vibration and the like, so that a contact error can be easily generated. There is a problem in that a connecting terminal of the circuit board is damaged by shock or friction generated between the pin members 24 and the circuit board. Also, there is a problem in that when lateral vibration is generated, the conventional pressure sensor 10 cannot absorb this lateral vibration appropriately. As described above, if the contact error between the conventional pressure sensor 10 and the electronic control unit is generated, this contact error acts as the factor affecting the steering and braking performances of a vehicle. Accordingly, development for a pressure sensor that can be connected to a circuit board of an electronic control unit through a new method is desired.

### BRIEF SUMMARY

The present invention is conceived to solve the aforementioned problems in the prior art. According to one embodiment, a pressure sensor is provided, which can be in stable connect with a circuit board of an electronic control unit, has a simple coupling structure without soldering, and can be securely mounted to prevent signal transmission or electrical connection caused by vibration and the like from being interrupted.

According to one embodiment, a pressure sensor has an improved inner structure to allow the pressure sensor to be stably connected to a circuit board, can prevent a coupling error from occurring to easily perform an assembling process, and can absorb lateral vibration.

According to one aspect, there is provided a pressure sensor installed to a hydraulic unit and being in contact with a circuit board of an electronic control unit to sense brake oil pressure. The pressure sensor comprises a connecting terminal formed on the circuit board of the electronic control board and comprising a press-fit terminal; a press-fit being in slidable and movable contact with the press-fit terminal; and a spring connecting the press-fit and the press-fit terminal.

Further, the press-fit terminal preferably comprises a central portion having a lower end coupled to the connecting terminal of the circuit board and electrically connected thereto, and a pair of extension portions extending upward from both sides of the central portion, the press-fit terminal having elasticity for allowing the ends of the extension portions to be in elastic contact with the press-fit. Furthermore, the press-fit terminal may comprise a guide portion formed on the end of the extension portion to be inclined outwardly for allowing the press-fit to be easily inserted thereinto.

In addition, according to another aspect, there is provided a pressure sensor installed to a hydraulic unit and being in contact with a circuit board of an electronic control unit to sense brake oil pressure. The pressure sensor comprises a contact terminal being in contact with the circuit board of the electronic control unit, wherein the contact terminal consists of a first coil spring portion being in contact with the circuit board of the electronic control unit and a second coil spring portion extending from the first coil spring portion to connect to the pressure sensor, the first coil spring portion having a winding density larger than that of the second coil spring portion.

Here, the first coil spring portion preferably has a spring constant larger than that of the second coil spring portion. In addition, the first coil spring portion preferably has a winding diameter smaller than that of the second coil spring portion.

### BRIEF DESCRIPTION OF THE SEVERAL VIEWS OF THE DRAWINGS

FIG. 1 is an exploded perspective view of a pressure sensor according to a prior art;

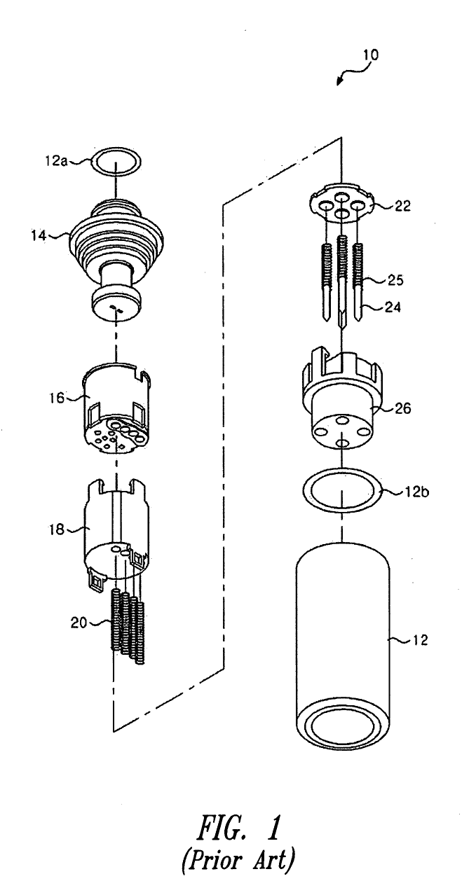

FIG. 2 is a schematic side view of the configuration of an anti-lock brake system, showing a pressure sensor according to one embodiment;

FIG. 3 is an exploded perspective view of the pressure sensor of FIG. 2.

FIG. 4 is a sectional view showing a state where the pressure sensor of FIG. 2 is connected to a circuit board by a connecting unit;

FIG. 5 is a schematic side view of an anti-lock brake system, showing a pressure sensor according to another embodiment;

FIG. 6 is an exploded perspective view of the pressure sensor of FIG. 5; and

FIG. 7 is an enlarged front view of a contact terminal of the pressure sensor of FIG. 5.

### DETAILED DESCRIPTION

Hereinafter, some embodiments will be explained in detail with reference to the accompanying drawings.

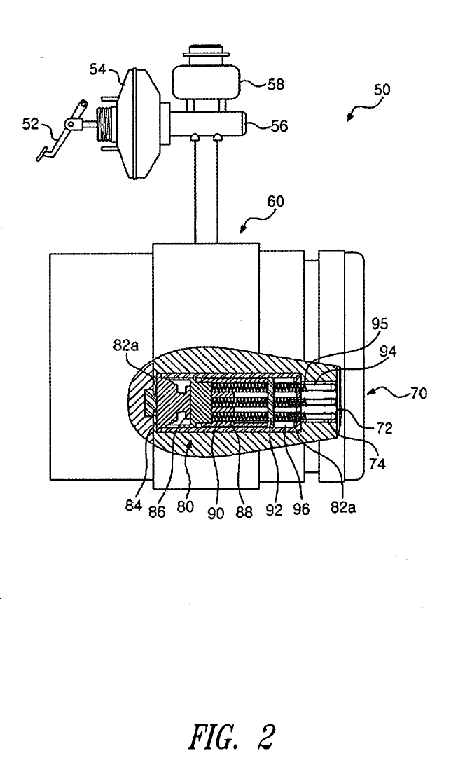

FIG. 2 is a view of the configuration of an anti-lock brake system, showing a pressure sensor according to a first embodiment of the present invention.

As shown in FIG. 2, a pressure sensor 80 according to one embodiment is mounted to a hydraulic unit 60 of an anti-lock brake system 50. The anti-lock brake system 50 comprises the hydraulic unit 60 to which a plurality of solenoid valves, low-pressure accumulators and high-pressure accumulators for adjusting brake oil pressure to be transmitted to the wheel brake, and an electronic control unit (ECU) 70 for controlling components that electronically operate.

The solenoid valve of the hydraulic unit 60 can adjust brake oil pressure of a wheel brake installed on a wheel. The wheel brake is rubbed with a wheel by the oil pressure of the solenoid valve to directly generate braking force. To this end, a pump for pumping brake oil is connected to the solenoid valve. The operation of the solenoid valve or the pump is electrically controlled by the electronic control unit 70.

In addition to the hydraulic unit 60 and the electronic control unit 70, the anti-lock brake system 50 comprises a boosting device 54 for generating boost force by a brake pedal force of a brake pedal 52 and a master cylinder 56 communicating with an oil storage tank 58 to transmit brake oil pressure to the wheel brake.

Furthermore, wheel sensors are installed to front and rear wheels for sensing a wheel speed and transmitting an electrical signal on the wheel speed to the electronic control unit 70.

The electronic control unit 70 receives an electrical signal on brake pressure of the master cylinder 56 sensed by the pressure sensor 80. Then, the electronic control unit 70 controls the opening/closing operation of the respective solenoid valves and the additional operation of a motor depending on the transmitted electric signal to thereby control the anti-lock operation of the brake. To this end, the electronic control unit 70 comprises a circuit board 72 to which an integrated circuit (IC) chip is mounted, wherein a program for anti-lock control is inputted in the IC chip.

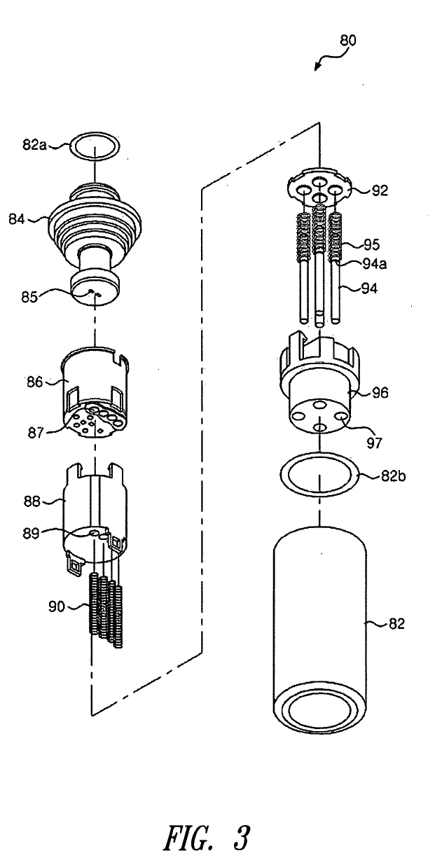

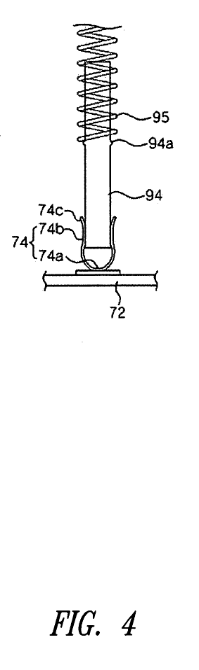

Referring to FIG. 3, which is an exploded perspective view of the pressure sensor 80 according to one embodiment, the pressure sensor 80 comprises a housing 82, and the housing 82 has O-rings 82a and 82b provided at upper and lower portions thereof. A sensor module 84 to which various sensors 85 are mounted is embedded in the upper portion of the housing 82. In addition, an electric component module 86 having a pressure-sensing unit and a control unit is coupled to a lower portion of the sensor module 84. Further, a lower portion of the electric component module 86 is provided with a connecting member to connect to the circuit board 72 of the electronic control unit 70 (FIG. 4).

The connecting member comprises an upper guide 88 coupled to the lower portion of the electric component module 86. In addition, a contact board 92 is installed to a lower portion of the upper guide 88. A connecting member is installed to the upper guide 88 to connect the contact board 92 and connecting terminals 87 provided at a lower portion of the electric component module 86 to each other. In order to stably transmit the signal when the contact board 92 is vibrated, the connecting member may comprise springs 90. Furthermore, the upper guide 88 is formed with a plurality of through holes 89 for providing spaces allowing the springs 90 to be inserted thereinto. The springs 90 inserted into the through holes 89 can be elastically and freely deformed in the longitudinal direction.

Further, in the pressure sensor 80, a connecting unit which is in direct contact with the circuit board 72 of the electronic control unit 70 is provided at a lower portion of the contact board 92.

FIG. 4 is a view showing a state where the pressure sensor 80 is connected to the circuit board by the connecting unit. Referring to FIG. 4, the pressure sensor 80 is connected to connecting terminals formed on the circuit board 72 of the electronic control unit 70. To this end, press-fit terminals 74 are utilized as the connecting terminals of the circuit board 72 of the electronic control unit 70. Also, the connecting unit of the pressure sensor 80 comprises press-fits 94 respectively connected to the press-fit terminals 74.

The movement of the press-fits 94 is guided by the lower guide 96 coupled to the lower portion of the contact board 92. The lower guide 96 is formed with a plurality of through holes 97, into each of which the press-fit 94 is movably inserted.

In a state where the press-fit 94 is inserted in and connected to the press-fit terminal 74, the press-fit slides therein to maintain the contact with the circuit board of the electronic control unit 70. In addition, a spring 95 which is in contact with the contact board 92 of the pressure sensor 80 is provided around each press-fit 94. The spring 95 is elastically deformed when the press-fit 94 is vibrated, and maintains the electrical connection with the contact board 92 of the pressure sensor 80. Accordingly, when the pressure sensor 80 and the electronic control unit 70 are vibrated, the elastic deformation of the springs 95 or the slide of the press-fits 94 in the press-fit terminals 74 absorbs the vibration.

Here, the press-fit terminal 74 comprises a central portion 74a having a lower end coupled to the connecting terminal of the circuit board 72 and electrically connected thereto, and a pair of extension portions 74b extending upward from both sides of the central portion 74a.

In addition, the press-fit terminal 74 is made of a material having predetermined elasticity, and ends of the pair of extension portions 74b are arranged to face each other, so that it possible to maintain the contact between the press-fit terminal and the press-fit 94 inserted by the elastic force.

Accordingly, when the press-fit 94 is inserted into the press-fit terminal 74, a gap between the extension portions 74b widens and the extension portions 74b come into contact with the press-fit, so that an electrical connection therebetween is maintained.

More preferably, the press-fit terminal 74 is formed with guide portions 74c for guiding the insertion of the press-fit 94. The guide portions 74c are respectively formed on the ends of the extension portions 74b to be inclined outward. Accordingly, when the press-fit 94 is inserted into the press-fit terminal 74, an end of the press-fit 94 comes into contact with the guide portions 74c, so that the extension portions 74b are bent outward, and then, the press-fit 94 is inserted into the press-fit terminal 74 and electrically connected thereto.

An operation of the pressure sensor according to the above-described embodiment will be described as follows.

First, the pressure sensor 80 senses brake pressure, which is generated by the driver's brake pedal force and increased by the master cylinder 56, and then transmits a signal on the increased pressure to the electronic control unit 70. Accordingly, the operation of the brake is controlled according to a pattern programmed in the electronic control unit 70.

The pressure sensor 80 is installed to the hydraulic unit 60 which is mounted with a plurality of solenoid valves, low pressure-accumulators and high pressure-accumulators. Then, the pressure sensor 80 is electrically connected to the circuit board 72 of the electronic control unit 70 to enable the electrical signal to be transmitted to the circuit board 72.

In such a pressure sensor 80, the press-fits 94 which are the electrical connecting terminals are inserted into the press-fit terminals 74 of the circuit board. The end of the press-fit 94 comes into contact with the guide portions 74c formed on the extension portions 74b of the press-fit terminal 74, and the press-fit 94 pushes the extension portions 74b outwardly and inserted in the press-fit terminal 74 as the press-fit 94 is continuously inserted therein.

When vibration is transmitted from the electronic unit 70 to the press-fit 94, the press-fit 94 is moved up and down in the press-fit terminal 74 to absorb the vibration.

In addition, as the contact board 92 slides in a state where the press-fit 94 is inserted into the press-fit terminal 74, it is possible to maintain the electrical connection between the contact board 92 and the circuit board 72. The electrical connection therebetween can also be maintained by the elastic deformation of the spring 95.

When the driver steps on the brake pedal 52 to transmit the brake pedal force to the master cylinder 56, the master cylinder 56 increases the brake pressure in proportion to the magnitude of the brake pedal force. Then, the brake pressure increased in the master cylinder 56 is sensed by the pressure sensor 80 of the hydraulic unit 60 (FIG. 2).

Then, the pressure sensor 80 senses the pressure of the master cylinder 56 and converts the sensed pressure into an electrical signal, and transmits the electrical signal to the circuit board 72 of the electronic unit 70 through the connecting means provided at the lower portion of the pressure sensor 80.

In the pressure sensor 80, the sensed pressure is converted into the electric signal through the sensor module 84 mounted with the sensor 85 and the electric component module 86 comprising the pressure-sensing unit and the control unit, and the electrical signal is transmitted to the contact board 92 via the springs 90 acting as the connecting member 90 and then transmitted to the press-fits 94 through the springs 95. Then, the press-fits 94 are connected to the press-fit terminals 74 of the circuit board 72 to transmit the electrical signal thereto.

On the other hand, it will be apparent that a structure of the contact terminal of the pressure sensor can be modified to withstand a lateral load.

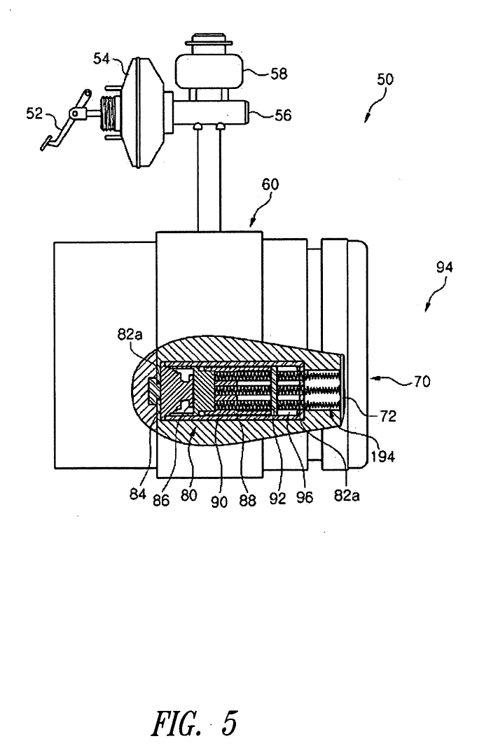

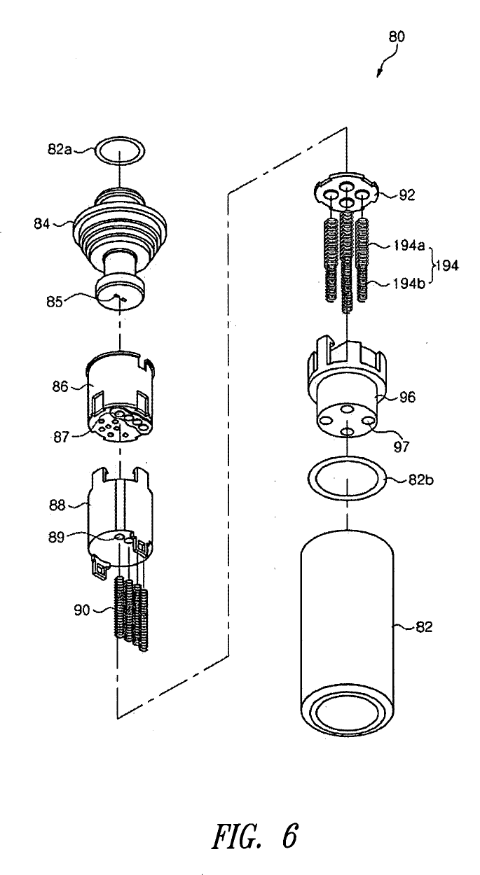

FIG. 5 is a view of an anti-lock brake system, showing a pressure sensor according to another embodiment, and FIG. 6 is an exploded perspective view of the pressure sensor of FIG. 5.

The pressure sensor 50 of this embodiment differs from and the pressure sensor according to the aforementioned embodiment in the connecting member connected to the circuit board of the electronic control unit. In other words, there is a difference in that the second embodiment has no press-fit employed therein and no press-fit terminal provided on the circuit board of the electronic control unit.

The connecting member is provided with the upper guide 88 coupled to the lower portion of the electric component module 86 and the contact board 92 at the lower portion of the upper guide 88. The upper guide 88 is provided with the connecting members 90 for connecting the contact board 92 and the connecting terminals 87 provided at the lower portion of the electric component module 86. In order to stably transmit the signal when the contact board 92 is vibrated, springs 90 may be employed as the connecting members 90. Furthermore, the upper guide 88 is formed with a plurality of through holes 89 for allowing the connecting members 90 to be elastically and freely deformed in the longitudinal direction.

Referring to FIG. 6, contact terminals 194, which are in direct contact with the circuit board 72 of the electronic control unit 70, are connected to the lower portion of the contact board 92. The movement of the contact terminals 194 is guided by the lower guide 96 coupled to the lower portion of the contact board 92. To this end, the lower guide 96 is formed with a plurality of through holes 97 in which the contact terminals 194 can be movably inserted.

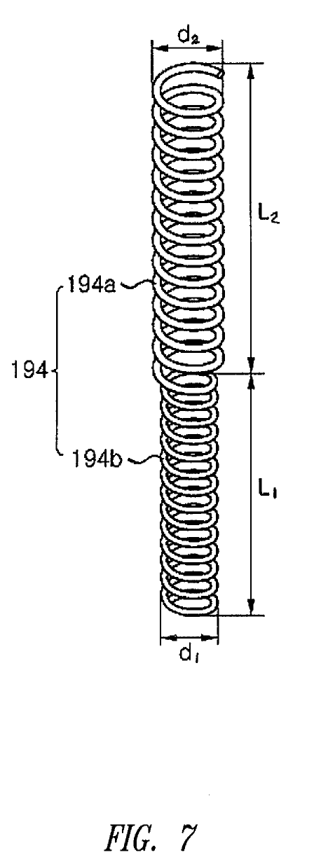

Referring to FIG. 7, the contact terminal 194 comprises a coil spring, which can be elastically deformed to a predetermined length in a state where the coil spring is in contact with the circuit board 72 of the electronic control unit 70. In addition, even though the circuit board 72 of the electronic control unit is laterally moved, the contact terminal 194 is bent and absorbs the deformation.

In the meantime, the contact terminal 194 is formed such that its upper portion differs from lower portion in winding density. That is, the contact terminal 194 consists of a first coil spring portion 194a to be in contact with the circuit board 72 and a second coil spring portion 194b extending from the first coil spring portion 194a and connected to the pressure sensor 80 through the contact board 92.

The first coil spring portion 194a has a winding density higher than the second coil spring portion 194b. Preferably, the first coil spring portion 194a is larger than the second coil spring portion 194b in spring constant, so that a gap between the windings of the first coil spring portion 194a becomes smaller than that of the second coil spring portion 194b. Furthermore, the contact terminal 194 is formed such that a winding diameter d1 of the first coil spring portion 194a is smaller than a winding diameter d2 of the second coil spring portion 194b. Accordingly, as compared with the second coil spring portion 194b, the first coil spring portion 194a can withstand larger pressure.

In addition, it is preferable that a length L1 of the first coil spring portion 194a and a length L2 of the second coil spring portion 194b are designed such that each of the first coil spring portion 194a and the second coil spring portion 194a has the appropriate elasticity depending on an amount of vibration of the circuit board 72 and the like.

The operation of the pressure sensor 80 according to this embodiment will be described as follows.

First, as the driver steps on the brake pedal 52 to transmit the brake pedal force to the master cylinder 56, the master cylinder 56 increases brake pressure in proportion to the magnitude of the brake pedal force. Then, the brake pressure increased in the master cylinder 56 is sensed by the pressure sensor 80 of the hydraulic unit 60.

Then, the pressure sensor 80 senses the pressure of the master cylinder 56 and converts the sensed pressure into an electrical signal, and is connected to, and transmits the electrical signal to, the circuit board 72 of the electronic unit 70 through the connecting means provided at the lower portion of the pressure sensor 80.

In the pressure sensor 80, the sensed pressure is converted into the electric signal through the sensor module 84 mounted with the sensor 85 and the electric component module 86 comprising the pressure-sensing unit and the control unit, and the electrical signal is transmitted to the contact board 92 via the springs acting as the connecting members 90 and then transmitted to the contact terminal 194 through the contact board 92. Then, the contact terminal 194 is connected to the circuit board 72 to transmit the electrical signal thereto.

In the meantime, if vibration is generated between the hydraulic unit 60 and the electronic control unit 70, the contact terminal 194 of the pressure sensor 80 absorbs the vibration. The second coil spring portion 194b of the contact terminal 194, which is in contact with the contact board 92, is rapidly deformed in the longitudinal or lateral direction, and the first coil spring portion 194a formed integrally with the second coil spring portion 194b absorbs small vibration as well as an elastic deformation to maintain the electrical connection with the circuit board 72.

Based on the foregoing, a pressure sensor according to one embodiment has a press-fit installed therein and connected to a press-fit terminal of the electronic control unit, so that there are advantages in that the pressure sensor can be stably connected to an electronic control unit and there is no need to perform a soldering work to allow an assembling work to be simply performed and the pressure sensor is simply installed. In addition, since the pressure sensor is stably connected to the electronic control unit, an electrical connection therebetween is not interrupted although a vibration is generated, and the electrical connection can be maintained stably and continuously. In addition, in a pressure sensor according to one embodiment has a coil spring consisting of two coil spring portions having different winding densities may be used as the contact terminal that is in electrical contact with the circuit board of the electronic control unit. Thus, the difference in winding density of the contact terminal makes it possible to rapidly absorb vibration and elastic deformation, so that a continuous electrical connection can be achieved.

Although the pressure sensor according to the present invention has been described with reference to the drawings and the preferred embodiments, the present invention is not limited thereto but defined by the appended claims. It will be understood by those skilled in the art that various modifications and changes can be made thereto within the scope of the invention defined by the appended claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A pressure sensing device comprising:
a hydraulic unit;
an electronic control unit having a circuit board;
a pressure sensor coupled to the hydraulic unit and electrically coupled to the circuit board of the electronic control unit to sense brake oil pressure;
a connecting terminal formed on the circuit board of the electronic control unit, the connecting terminal having a press-fit terminal;
a press-fit slidably coupled to the press-fit terminal; and
a biasing member connecting the press-fit and the press-fit terminal.

2. The pressure sensing device as claimed in claim 1 wherein the press-fit terminal includes a central portion having a lower end coupled to the connecting terminal of the circuit board and electrically connected thereto, and a pair of extension portions extending upward from both sides of the central portion, the press-fit terminal having elasticity for allowing the ends of the extension portions to be in elastic contact with the press-fit.

3. The pressure sensing device as claimed in claim 2 wherein the press-fit terminal includes a guide portion formed on the end of the extension portion to be inclined outwardly for allowing the press-fit to be easily inserted thereinto.

4. The pressure sensing device as claimed in claim 1 wherein the biasing member includes a spring.

5. A pressure sensing device comprising:
a hydraulic unit;
an electronic control unit having a circuit board;
a pressure sensor electrically coupled to the circuit board of the electronic control unit to sense brake oil pressure; and
a contact terminal electrically coupled to the circuit board of the electronic control unit, the contact terminal having a first coil spring portion electrically coupled to the circuit board of the electronic control unit and a second coil spring portion extending from the first coil spring portion to connect to the pressure sensor, the first coil spring portion having a winding density larger than that of the second coil spring portion.

6. The pressure sensing device as claimed in claim 5 wherein the first coil spring portion has a spring constant larger than a spring constant of the second coil spring portion.

7. The pressure sensing devicer as claimed in claim 5 wherein the first coil spring portion has a winding diameter smaller than a winding diameter of the second coil spring portion.

8. A braking system hydraulic unit pressure sensor to sense brake oil pressure of the braking system, comprising:
an electronic control unit having a circuit board and a connecting terminal formed on the circuit board and comprising a press-fit terminal;
a press-fit being in slidable and movable contact with the press-fit terminal; and
a spring connecting the press-fit and the press-fit terminal.

9. The pressure sensor as claimed in claim 8 wherein the press-fit terminal comprises a central portion having a lower end coupled to the connecting terminal of the circuit board and electrically connected thereto, and a pair of extension portions extending upward from both sides of the central portion, the press-fit terminal having elasticity for allowing the ends of the extension portions to be in elastic contact with the press-fit.

10. The pressure sensor as claimed in claim 9 wherein the press-fit terminal comprises a guide portion formed on the end of the extension portion to be inclined outwardly for allowing the press-fit to be easily inserted thereinto.

11. A pressure sensor of a brake system hydraulic unit configured to contact a circuit board of an electronic control unit to sense brake oil pressure, comprising:
a contact terminal configured to contact the circuit board of the electronic control unit during operation, wherein the contact terminal consists of a first coil spring portion to contact the circuit board of the electronic control unit and a second coil spring portion extending from the first coil spring portion to connect to the pressure sensor, the first coil spring portion having a winding density larger than that of the second coil spring portion.

12. The pressure sensor as claimed in claim 11 wherein the first coil spring portion has a spring constant larger than a spring constant of the second coil spring portion.

13. The pressure sensor as claimed in claim 11 wherein the first coil spring portion has a winding diameter smaller than a spring contstant of the second coil spring portion.
